(19) United States
(12) Patent Application Publication
(10) Pub. No.: US 2022/0088729 A1
(43) Pub. Date: Mar. 24, 2022

(54) ROBOTIC ASSEMBLY STATIONS

(71) Applicant: Ford Global Technologies, LLC, Dearborn, MI (US)

(72) Inventors: Alan George Dry, Grosse Pointe Woods, MI (US); Robert William Miller, Inkster, MI (US); David A. Brown, Plymouth, MI (US)

(73) Assignee: Ford Global Technologies, LLC, Dearborn, MI (US)

(21) Appl. No.: 17/025,212

(22) Filed: Sep. 18, 2020

(51) Int. Cl. B23P 21/00; B23P 19/04; B25J 11/00

(52) U.S. Cl. CPC B23P 21/004; B25J 11/005; B23P 19/04

(57) ABSTRACT

An assembly station includes at least one build platform table configured to move about three orthogonal axes, at least one part placement robot configured to position and hold components on and above the at least one build platform table, and at least one fused filament fabrication robot with a printer head configured to fused filament weld at least two components together. The at least one build platform table is configured to rotate during assembly of a plurality of components such that the fused filament is extruded vertically from the printer head during fused filament welding of the at least two components together. Also the at least one part placement robot is configured to position and hold a first component a predetermined distance from a second component during fused filament welding of the first component to the second component.

### FIELD

The present disclosure relates to assembling components, and particularly to stations for robotic assembly of components.

### BACKGROUND

The statements in this section merely provide background information related to the present disclosure and may not constitute prior art.

Assembling components to form an assembly or sub-assembly of the components (referred to herein simply as an “assembly” or “assembly of components”) is commonly performed by arranging the components into desired positions using one or more fixtures, and then attaching or coupling the components together using clips, fasteners and/or welding. For example, an individual or robot places the components on or in one or more fixtures, the fixture(s) securely hold the components in the desired positions, and an operator or robot attaches or couples the components together. The assembly of components is then released from the fixture(s) and moved to a separate location for storage, shipping, and/or assembly within another component or assembly of components. The cycle is repeated to manufacture another assembly of components such that a plurality of assemblies (e.g., a large number of assemblies) is produced in a time and cost efficient manner. However, the manufacture of fixtures can be cost prohibitive and the use of fixtures can be inflexible when different components are used and/or variations of an assembly are needed.

These issues with the manufacture and use of fixtures for the manufacture of assemblies of components, along with other issues related to assembly of components, are addressed by the present disclosure.

### SUMMARY

In one form of the present disclosure, an assembly station includes at least one build platform table configured to move about three orthogonal axes, at least one part placement (PPL) robot configured to position and hold components on and above the at least one build platform table, and at least one fused filament fabrication (FFF) robot with a printer head configured to fused filament weld at least two components together. Also, the at least one build platform table is configured to rotate during assembly of a plurality of components such that the fused filament is extruded vertically from the printer head during fused filament welding of the at least two components together.

In some variations, the at least one PPL robot is configured to position and hold a first component a predetermined distance from a second component during fused filament welding of the first component to the second component with the at least one FFF robot. In such variations, the predetermined distance is a welding gap between the first component and the second component and the at least one FFF robot and the printer head are configured to extrude fused filament into the welding gap. In other variations, the predetermined distance is an isolation gap between the first component and the second component.

In at least one variation, the at least one build platform table is configured to hold a lens. The at least one PPL robot is configured to hold a lighting module adjacent to the lens with the predetermined distance between the lens and the lighting module, and the at least FFF robot is configured to fused filament weld the lighting module to the lens. In some variations, the at least one FFF robot is also configured to extrude sealant into at least a portion of the predetermined distance between the lens and the lighting module. And in at least one variation, the predetermined distance between the lens and the lighting module is a welding gap and the at least one build platform table and the at least one PPL robot are configured to move the lens and the lighting module together such that the printer head extrudes fused filament vertically into the welding gap to fused filament weld the lighting module to the lens.

In some variations, the at least one build platform table, the at least one PPL robot and the at least FFF robot are configured to assemble at least two sub-assemblies and configured to assemble the at least two sub-assemblies and form a main assembly. In such variations, the at least two sub-assemblies can be at least two head lamp sub-assemblies and the main assembly is a head lamp main assembly.

In at least one variation, the at least one build platform table is at least two build platform tables and the at least one PPL robot and the at least one FFF robot are configured to assemble sub-assemblies on one of the at least two build platform tables and to assemble to the sub-assembles into a main assembly on another of the at least two platforms.

In some variations, the at least one build platform table is at least two build platform tables and the at least one PPL robot and the at least one FFF robot are configured to assemble a first set of sub-assemblies on one of the at least two build platform tables and to assemble a second set of sub-assembles on another of the at least two platforms. In such variations, the at least one PPL robot and the at least one FFF robot can be configured to assemble the first set of sub-assembles and the second set of sub-assemblies to form main assemblies.

In at least one variation, the at least one build platform table and the at least one PPL robot are mounted to a floor structure, and the at least one FFF robot is mounted to a roof structure above the at least one build platform table. And in some variations, the at least one build platform table is at least two build platform tables mounted to the floor structure, the at least one PPL robot is at least two PPL robots mounted to the floor structure, and the at least one FFF robot is at least two FFF robots mounted to the roof structure above the at least two build platform tables.

In another form of the present disclosure, an assembly station includes at least one build platform table configured to move about three orthogonal axes, at least PPL robot configured to position and hold components on and above the at least one build platform table, and at least one FFF robot with a printer head configured to fused filament weld at least two components together. The at least one PPL robot is configured to position and hold a first component a predetermined distance from a second component and the at least one build platform table is configured to rotate such that fused filament is extruded vertically from the printer head to fused filament weld the at least two components together.

In some variations, a first portion of the predetermined distance is a welding gap between the first component and the second component and a second portion of the predetermined distance is an isolation gap between the first component and the second component. And in such variations, the at least one FFF robot and the printer head are configured to extrude fused filament into the welding gap.

In still another form of the present disclosure, an assembly station includes two build platform tables configured to move about three orthogonal axes, two part PPL robots configured to position and hold components on and above the two build platform tables, and a FFF robot with a printer head configured to fused filament weld at least two components together. Also, the two PPL robots are configured to position and assemble a first component a predetermined distance from a second component such that fused filament is extruded vertically from the printer head to fused filament weld the first component to the second component.

In some variations, the first component is a lens, the second component is a lighting module, the predetermined distance between the lens and the lighting module is a welding gap, at least one of the two build platform tables and at least one of the two PPL robots are configured to move the lens and the lighting module together such that the printer head extrudes fused filament vertically into the welding gap to fused filament weld the lighting module to the lens.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a top view of an assembly station according to one form of the present disclosure;

FIG. 1B is a side view of the assembly station in FIG. 1B;

FIG. 2 is a side view of components assembled with the assemble station in FIGS. 1A-1B according to the teachings of the present disclosure;

FIG. 3 is a side view of the assembled components in FIG. 2 being welded together according to the teachings of the present disclosure;

FIG. 4A is a side view of two components being assembled and positioned relative to each other according to the teachings of the present disclosure;

FIG. 4B is a side view of the two components assembled at desired positions and being welded together according to the teachings of the present disclosure;

FIG. 5A is an enlarged view of section 5-5 in FIG. 4B showing a negative delta resulting from positioning a first component in contact with a second component;

FIG. 5B is an enlarged view of section 5-5 in FIG. 4B showing a positive delta resulting from positioning a first component in contact with a second component;

FIG. 5C is an enlarged view of section 5-5 in FIG. 4B showing a no delta resulting from positioning a first component a predefined distance from a second component;

FIG. 6 is a side view of an example of two components assembled at desired positions and welded together according to teachings of the present disclosure;

FIG. 7 is a side view of another example of two components assembled at desired positions and welded together according to teachings of the present disclosure;

FIG. 8 is a side view of still another example of two components assembled at desired positions and welded together according to teachings of the present disclosure;

FIG. 9 is a side view of yet another example of two components assembled at desired positions and welded together according to teachings of the present disclosure;

FIG. 10 is a side view of still yet another example of two components assembled at desired positions and welded together according to teachings of the present disclosure;

FIG. 11 is a side view of an example of two components assembled at desired positions and releasably attached to each other according to teachings of the present disclosure;

FIG. 12A is a top view of another example of two components assembled at desired positions and releasably attached to each other according to teachings of the present disclosure;

FIG. 12B is a side view of the two components in FIG. 12A assembled and releasably attached to each other;

FIG. 13 is a top view of an assembly station according to another form present disclosure;

FIG. 14 is a side view of an assembly station according to still another form present disclosure; and

FIG. 15 is a flowchart for a method of manufacturing an assembly of components according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides assembly stations for the assembly and welding, e.g., fused filament welding, of a plurality of components together without or with a reduced number of fixtures. In addition, the assembly stations according to the teachings of the present disclosure reduce the additive effect of component tolerance and enhance the use of fused filament fabrication during the manufacture of assemblies of components.

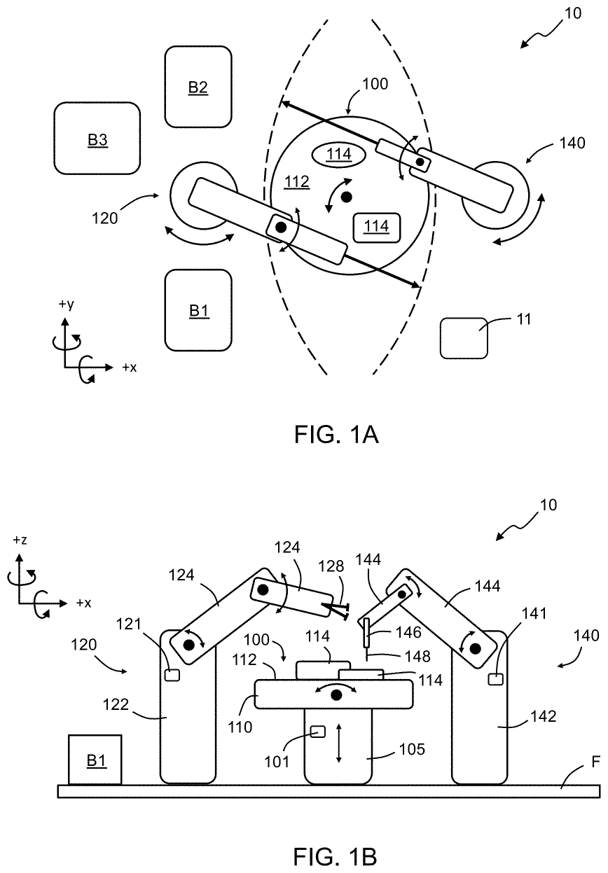

Referring to FIGS. 1A and 1B, an assembly station 10 according to one form of the present disclosure is shown. The assembly station 10 includes a build platform table 100, a part placement (PPL) robot 120, and a fused filament fabrication (FFF) robot 140. The build platform table 100 has a base 105, a platform 110 with an upper (+z direction) surface 112, and at least one nest 114. In some variations, the nest 114 is a mechanical fixture for holding a specific component on the upper surface 112. In the alternative, the at least one nest is a generic clamp for holding a component on the upper surface 112. As used herein, the phrase “generic clamp” refers to a clamp that can be used to hold a plurality of different sized and shaped parts. Non-limiting examples of a generic clamp include a mechanical clamp (also known as a “vise”) with at least one moveable jaw, hydraulic clamp with at least one moveable jaw that holds at least one component, a pneumatic clamp with at least one moveable jaw that holds at least one component, a magnetic clamp that holds at least one component with a magnetic field, a vacuum clamp that holds at least one component with a vacuum force, among others. In some variations, and as shown in FIGS. 1A and 1B, the platform 110 with the upper surface 112 is operable to move about three orthogonal axes. As used herein, the phrase “move about three orthogonal axes” refers to translating along the three orthogonal axes and/or rotating about the three orthogonal axes. In at least one variation, the build platform table 100 includes a controller 101 configured to command the platform 110 with the upper surface 112 to move about three orthogonal axes and/or activate the nest 114 to hold a component. In the alternative, or in addition to, the assembly station 10 includes a controller 11 configured to command the build platform table 100 to move about three orthogonal axes, activate the nest 114 to hold a component, and/or instruct the controller 101 to command the build platform table 100 to move about three orthogonal axes and/or activate the nest 114 to hold a component.

The PPL robot 120 has a base 122, at least one arm 124, and at least one end effector 128. In some variations, the PPL robot 120 is operable to move and operate the at least one end effector 128 about three orthogonal axes. In at least one variation, the PPL robot 120 includes a controller 121 configured to command the PPL robot 120 to move about three orthogonal axes and/or command the end effector 128 to grasp and hold a component. In the alternative, or in addition to, the assembly station 10 includes a controller 11 configured to command the PPL robot 120 to move about three orthogonal axes, command the end effector 128 to grasp and hold a component, and/or instruct the controller 121 to command the PPL robot 120 to move about three orthogonal axes and/or command the end effector 128 to grasp and hold a component.

The FFF robot 140 has a base 142, at least one arm 144, and at least one FFF printer head 146 (also referred to herein simple as “printer head”) operable to extrude fused filament 148. Similar to the PPL robot 120, in some variations the FFF robot 140 is operable to move the at least one FFF printer head 146 about three orthogonal axes. However, and as described in greater detail below, in some variations of the present disclosure the build platform table 100 and/or the PPL robot 120 are configured to position an assembly of components such that the fused filament 148 is extruded from the printer head 146 vertically onto or between at least two assembled components. In at least one variation, the FFF robot 140 includes a controller 141 configured to command the FFF robot 140 to move about three orthogonal axes and/or command the printer head 146 to extrude the fused filament 148. In the alternative, or in addition to, the controller 11 can be configured to command the FFF robot 140 to move about three orthogonal axes, command the printer head 146 to extrude the fused filament 148, and/or instruct the controller 141 to command the FFF robot 140 to move about three orthogonal axes and/or command the printer head 146 to extrude the fused filament 148.

In some variations of the present disclosure, the build platform table 100, the PPL robot 120 and/or the FFF robot 140 are secured to a floor structure F. For example, the base 105 of the build platform 100, the base 122 of the PPL robot 120, and/or the base 142 of the FFF robot 140 is secured to the floor structure F.

During operation, the PPL robot 120 is configured to, and does, grasp one or more components (not labeled in FIGS. 1A-1B) from a container B1 and/or B2 and holds the component(s) on or above the upper surface 112. Also, the FFF robot 140 joins or attaches the components together with at least one fused filament weld. For example, in some variations, the at least one end effector 128 grasps a first component from the container B1 and/or B2, positions the first component on the at least one nest 114, the at least one nest 114 holds the first component, the at least one end effector 128 releases the first component and grasps a second component from the container B1 and/or B2, and positions the second component proximate to the first component. The FFF robot 140 positions the printer head 146 proximate to a desired position between the first component and the second component (e.g., at a gap or groove), and the printer head 146 extrudes fused filament 148 onto and/or into the desired position to form a fused filament weld between the first component and the second component.

It should be understood that the fused filament weld securely attaches the first component to the second component. In addition, the FFF robot 140 can be used to build structure (i.e., 3D print) of an assembly. In some variations, and after fused filament welding the first component to the second component and forming a first and second component assembly, the nest 114 releases the first component and the PPL robot 120 moves the first and second component assembly to a container or location ‘B3’ for subsequent processing of the assembly. It should also be understood that the controller 11, controller 101, controller 121, and controller 141 are configured to instruct, receive instructions and command the build platform table 100, PPL robot 120, and FFF robot 140 to move, grasp, and operate in a synchronous manner such that a plurality of components are assembled together.

The printer head 146 can use and extrude fused filament 148 having different diameters to accommodate or for use in welding components with different thicknesses (e.g., different wall thicknesses). The printer head 146 can also use and extrude fused filament 148 having different mechanical properties for fused filament welding of different or specific components. In some variations, the fused filament 148 includes weight saving additives, high strength fibers, electrically conductive additives, and/or thermally conductive additives, among others. In at least one variation, the fused filament 148 is in the form of soft elastomeric material used to provide localized sealing and/or flexibility. In some variations, the fused filament 148 is a material that is porous to gaseous H₂O such that humidity is vented from an enclosure. And in at least one variation the fused filament 148 includes one or more color additives such that a color of a fused filament weld matches one or more assembled components. In such a variation the fused filament weld can have the appearance of two shot molding.

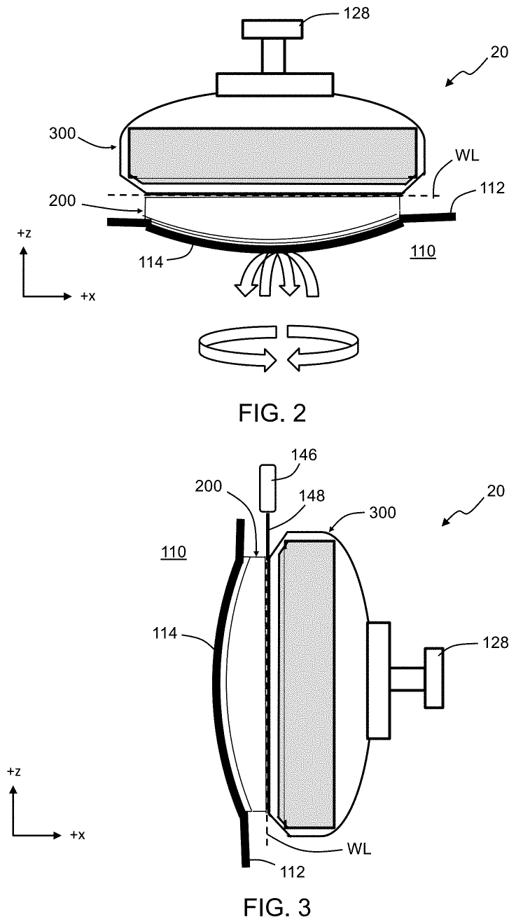

As noted above, the build platform table 100, the PPL robot 120, and/or the FFF robot 140 is/are operable to move about three orthogonal axes, and in some variations the build platform 100 and the PPL robot 120 are configured to move about three axes such that the fused filament 148 is extruded and extends vertically from the printer head 146 to form a fused filament weld between and/or on at least two components. For example, and with reference to FIGS. 2 and 3, the PPL robot 120 assembles a head light assembly 20 with a lighting module 300 adjacent to a polycarbonate (PC) lens 200 in FIG. 2 such that a weld line ‘WL’ is formed between the PC lens 200 and the lighting module 300. Also, the build platform 100 and the end effector 128 (i.e., the PPL robot 120 with the end effector 128) rotate the head light assembly 20 as shown in FIG. 3 such that the printer head 146 can and is extruding fused filament 148 in a vertical direction (z direction) onto the weld line ‘WL’ between the PC lens 200 and the lighting module 300. In the alternative, or in addition to, the FFF robot 140 is configured to extrude sealant into at least or portion of a predetermined distance between the PC lens 200 and the lighting module 300.

In some variations the nest 114 is vacuum nest 114 that grasps and/or holds the PC lens 200 when the at least one end effector 128 positions the PC lens 200 adjacent and/or onto the vacuum nest 114. And while the nest 114 holds the PC lens 200, the at least one end effector 128 grasps the lighting module 300 and positions and holds the lighting module 300 adjacent and proximate to the PC lens 200 such that the weld line ‘WL’ is formed between the PC lens 200 and the lighting module 300. In some variations the welding line WL is defined by a predefined distance (also referred to herein as a “gap”) between the PC lens 200 and the lighting module 300. It should be understood that the fused filament 148 is in a semi-liquid state during extrusion from the printer head 146. That is, as the fused filament 148 is extruded from the printer head 146, the material cannot support or hold its own weight and thereby can sag or droop if not extruded vertically as shown in FIG. 3. Accordingly, rotating the PC lens 200 and the lighting module 300, and providing for the vertical extrusion of the fused filament 148 from the printer head 146 enhances welding and attaching of the lighting module 300 to the PC lens 200. Also, rotating the PC lens 200 and the lighting module 300 as illustrated in FIGS. 2-3 provides for assembly of the PC lens 200 and the lighting module 300 without the use of a fixture to hold the lighting module 300 relative to the PC lens 200 thereby allowing or providing for positioning the lighting module 300 independent of (i.e., not in contact with) the PC lens 200 as described in greater detail below.

It should be understood that PC and PC lens are typically used in FFF due to the amorphous nature of the material, i.e., PC not have a glass transition temperature that defines its freezing point. However, the tilting table (i.e., the build platform table 100) enables a vertical poured or extruded deposition of weld material (i.e., fused filament 148) that fills an open channel between two components. Accordingly, two components can be made out of PC via High Pressure Injection Molding and then weld them together using the teachings of the present disclosure.

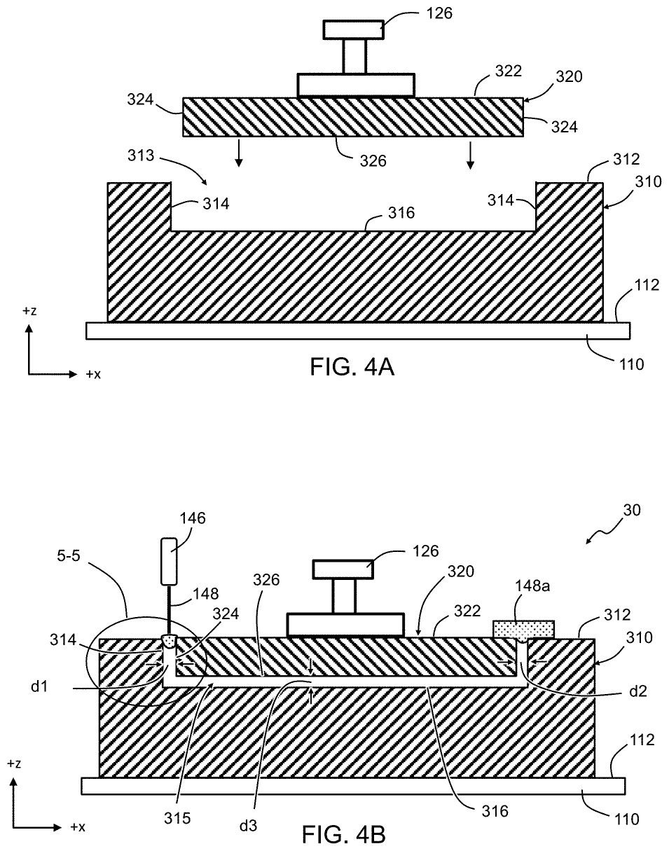

Referring to FIGS. 4A-4B, a side view of two components being assembled and positioned relative to each other is shown in FIG. 4A and a side view of the two components assembled at desired positions and being welded together to form a sub-assembly 30 is shown in FIG. 4B. Particularly, and with reference to FIG. 4A, a first component 310 is positioned on the upper surface 112 and the end effector 128 is moving a second component 320 moved towards the first component 310. The first component 310 has an upper (+z direction) surface 312, and a pair of side surfaces 314 and a bottom surface 316 defining an opening 313 (i.e., an open space). The second component 320 has an upper surface 322, a pair of side surfaces 324, and a lower surface 326. The second component 320 is dimensioned to fit within the opening 313.

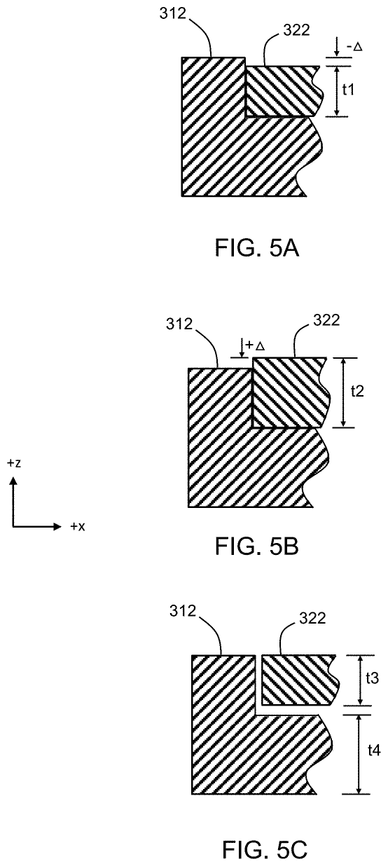

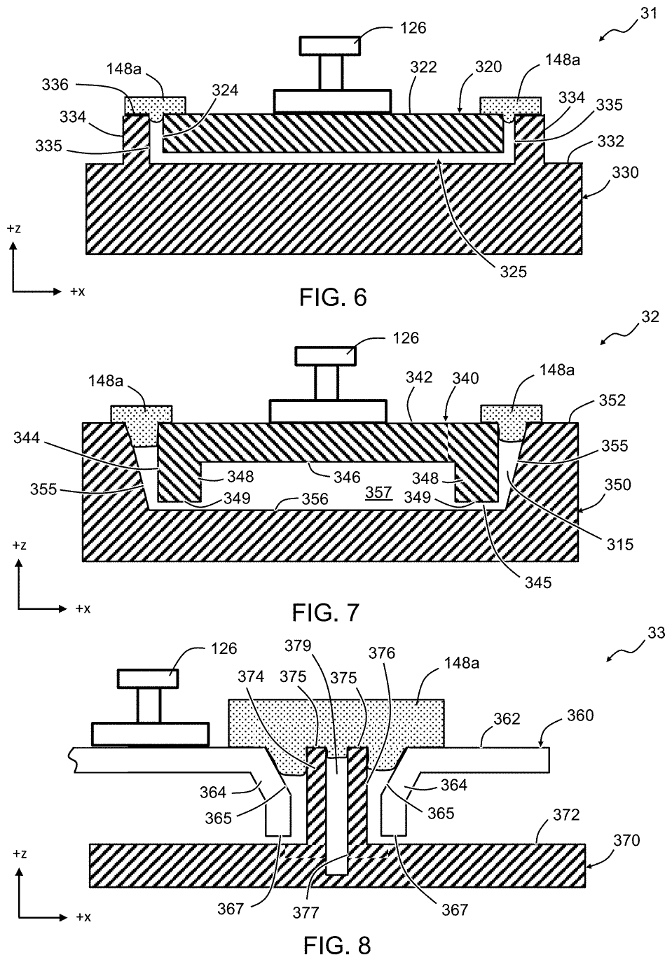

Referring now to FIG. 4B, the PPL robot 120 with the end effector 126 lowers (−z direction) the second component 320 into a desired position within the opening 313 such that the upper surface 322 of the second component at 320 is at the same height (z direction) as the upper surface 312 of the first component 310. In addition, and as the PPL robot holds the second component 320 in the desired position within the opening 313, the FFF robot 140 moves the printer head 146 such that fused filament 148 is vertically extruded from the printer head 146 and a fused filament weld 148a is formed and attaches the second component 320 to the first component 310. As shown in FIG. 4B, in some variations, the PPL robot 120 holds the second component 320 relative to the first component 310 such that a predefined distance 315 is present between the two components 310, 320. For example, a first gap ‘d1’ is provided and is present between the side surfaces 314, 324 on the left hand side (−x direction) of sub-assembly 30, a second gap ‘d2’ is provided and is present between the side surfaces 314, 324 on the right hand side (+x direction) of sub-assembly 30, and a third gap ‘d3’ is provided and is present between upper surface 316 of the first component 310 and the lower surface 326 of the second component 320. In some variations, the first gap d1 is equal to the second gap d2, while in other variations the first gap is not equal to d2. Also, the third gap may or may not be equal to d1 and/or d2. And in at least one variation, the first and second gaps d1, d2 are welding gaps, i.e., gaps where a fused filament weld is formed, and the third gap 53 is an isolation gap that “isolates” dimensional tolerances of the first component 310 from the second component 320 and/or isolates dimensional tolerances of the second component 320 from the first component 310 as described below with reference to FIGS. 5A-5C. Accordingly, in some variations the predefined distance 315 has a first portion that is a welding gap (e.g., d1, d2) and a second portion that is an isolation gap (e.g., d3).

It should be understood that the fused filament weld 148a forms a bond between first component 310 and the second component 320. For example, the fused filament weld 148a is bonded to the upper surface 312 of the first component 310 in the upper surface 322 of the second component 320. In some variations, they fused filament weld 148a is bonded to the side surface 314 of the first component 310 and the side surface 324 of the second component at 320. That is, in some variations the fused filament 148 flows into the gap d1 and/or d2 and bonds with the side surface 314 and/or side surface 324.

As shown in FIG. 4B, the second component 320 is positioned and held independent of the first component 310. Stated differently, in some variations the second component 320 is not in physical contact with the first component 310 when the second component 320 is held in a desirable and predefined position and the first and second components 310, 320 are fused filament welded to each other.

It should be understood that assembling the first and second components 310, 320 (and other components described and discussed herein) with a predefined distance or gap therebetween reduces or eliminates dimensional errors in the size(s) and shape(s) of assembly of components according to the teachings of the present disclosure. For example, and referring to FIGS. 5A-5B, assembling the first and second components 310, 320 in contact with each other (for example, using fixtures) can result in a negative delta (−Δ) (FIG. 5A) or a positive delta (+Δ) (FIG. 5B) between a desired position of the upper surface 322 (i.e., level or at the same height (z direction) as the upper surface 312) and an actual position of the upper surface 322 depending on an actual thickness ‘t1’ or ‘t2’ of the second component 320. In contrast, assembling the first and second components 310, 320 with a predetermined distance therebetween (FIG. 5C) allows for the actual thickness t3 of the second component 320 to be accommodated for such that the upper surface 322 is positioned at the same level of height as the upper surface 312 independent of the thickness ‘t3’ of the second component 320. Also, assembling the first and second components 310, 320 with a predetermined distance therebetween (FIG. 5C) allows for the upper surface 322 to be positioned at the same level of height as the upper surface 312 independent of the thickness ‘t4’ of the first component 310 where the opening 313 is located. That is, the gap d3 (FIG. 4B) isolates dimensional tolerances of the first component 310 from the second component 320 and/or isolates dimensional tolerances of the second component 320 from the first component 310. Accordingly, small within (or without) tolerance variations of the shape and/or size of the first component 310 are not compounded by small within (or without) tolerance variations of the shape and/or size of the second component 320 and assemblies with enhanced dimensional accuracy and/or dimensional consistency are provided.

Referring now to FIG. 6, a side view of two components assembled at desired positions and fused filament welded together to form a sub-assembly 31 is shown. Particularly, the second component 320 is fused filament welded (via a fused filament weld 148a) to a third component 330 having an upper surface 332 and a pair of posts or a ridge 334 extending upwardly (+z direction) from the upper surface 322. The pair of posts or a ridge 334 have/has a side surface 335 and an upper surface 336, and the fused filament weld 148a is bonded to the upper surface 322 of the second component 320, upper surface 336 of the third component 336, side surface(s) 324 of the second component 320, and/or side surface(s) 335 of the third component 330 such that the second component 320 is securely attached to the third component 330. In addition, the PPL robot 120 positions the second component 320 such that a predefined distance 325 is present between the second component 320 and the third component 330. Accordingly, and as described above with respect to FIG. 4B, the second component 320 is positioned and held independent of the third component 310. It should be understood that the build platform table 100 and the PPL robot 120 can position the second and third components 320, 330 adjacent to each other in an orientation different than shown in FIG. 6, and then rotate the second and third components 320, 330 such that the printer head 146 extrudes fused filament 148 vertically to form the fused filament weld 148a.

Referring to FIG. 7, a side view of two components assembled at desired positions and fused filament welded together to form a sub-assembly 32 is shown. Particularly, a fourth component 340 is fused filament welded (via a fused filament weld 148a) to a fifth component 350. The fourth component 340 has an upper surface 342, at least one side surface 344, a lower surface 346, and a pair of posts or ridge 348 extending downwardly (−z direction) from the lower surface 346. The fifth component 350 has an upper surface 352, at least one side surface 355, and a lower surface 356 defining an opening or space 357. The fused filament weld 148a is bonded to the upper surface 342, the upper surface 352, side surface(s) 344, and/or side surfaces 355 such that the fourth component 340 is securely attached to the fifth component 350. In addition, the PPL robot 120 positions the fourth component 340 relative to the fifth component 350 such that a predefined distance 345 is between a lower surface 349 of the pair of posts or ridge 348 and the lower surface 356 of the fifth component 350. Also, gaps (not labeled) are provided or present between the at least one side surface 344 of the fourth component and the at least one side surface 355 of the fifth component 350. Accordingly, and as described above with respect to FIG. 4B, the fourth component 340 is positioned and held independent of the fifth component 350. And it should be understood that the build platform table 100 and the PPL robot 120 can position the fourth and fifth components 340, 350 adjacent to each other in an orientation different than shown in FIG. 7, and then rotate the fourth and fifth components 340, 350 such that the printer head 146 extrudes fused filament 148 vertically to form the fused filament weld 148a.

Referring to FIG. 8, a side view of two components assembled at desired positions and fused filament welded together to form a sub-assembly 33 is shown. Particularly, a sixth component 360 is fused filament welded (via a fused filament weld 148a) to a seventh component 370. The sixth component 360 has an upper surface 362 and at least one leg 364 with an inner side surface 365 extending downwardly (−z direction) from the upper surface 362. The sixth component 360 also has an opening (not labeled) between or within (x direction) the at least one leg 364. The seventh component 370 has an upper surface 372 and a pair of legs or ridge 374 that have/has an upper surface 375, an outer side surface 376, and an inner side surface 377. An opening or gap 379 is defined between or within the pair of legs or ridge 374. For example, in some variations the pair of legs or ridge 374 define a standard screw tower configured to accept and hold a screw. The fused filament weld 148a is bonded to the upper surface 362, the upper surface 375, the side surface(s) 365, the outer side surface(s) 376, and/or the inner side surface(s) 377 such that the sixth component 360 is securely attached to the seventh component 370. In addition, the PPL robot 120 positions the sixth component 360 relative to the seventh component 370 such that a predefined distance (not labeled) is between a lower surface 367 of the at least one leg 364 and the upper surface 372 of the seventh component 370. Also, gaps (not labeled) are provided or present between the at least one side surface 365 of the sixth component and the at least one outer side surface 376 of the seventh component 370. Accordingly, and as described above with respect to FIG. 4B, the sixth component 360 is positioned and held independent of the seventh component 370. And it should be understood that the build platform table 100 and the PPL robot 120 can position the sixth and seventh components 360, 370 adjacent to each other in an orientation different than shown in FIG. 8, and then rotate the sixth and seventh components 360, 370 such that the printer head 146 extrudes fused filament 148 vertically to form the fused filament weld 148a.

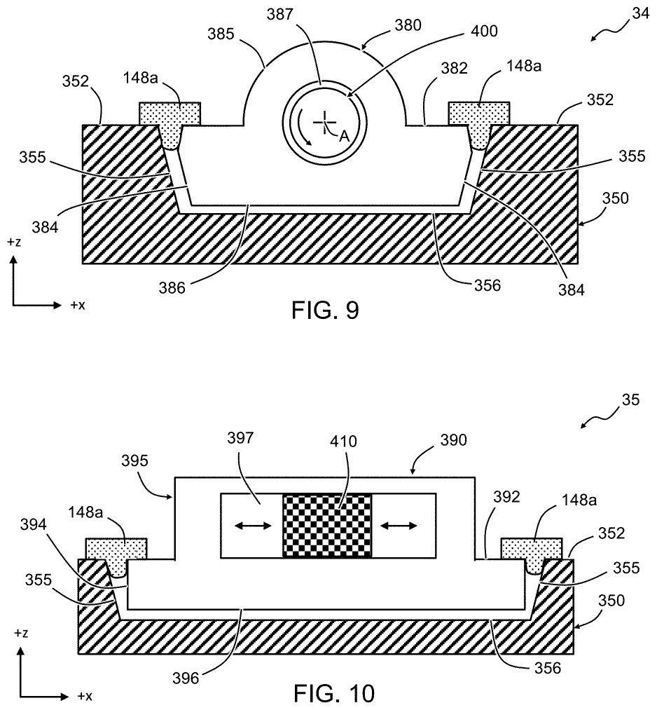

Referring now to FIG. 9, a side view of two components assembled at desired positions and fused filament welded together to form a sub-assembly 34 is shown. Particularly, an eighth component 380 is fused filament welded (via a fused filament weld 148a) to the fifth component 350. As noted above, the fifth component 350 has the upper surface 352, at least one side surface 355, and the lower surface 356 defining the opening or space 357 (FIG. 7). The eighth component 380 has an upper surface 382, at least one side surface 384, and a lower surface 386. In addition, the eighth component 380 has an upper portion 385 extending from the upper surface 382 and an opening 387. In some variations, a separate component or feature 400 is disposed within the opening 387. For example, and as shown in FIG. 9, a rotating part 400 is disposed within opening 387 and is configured to rotate about an axis A. The fused filament weld 148a is bonded to the upper surface 352, the upper surface 382, the side surface(s) 355, and/or the side surface(s) 384 such that the eighth component 380 is securely attached to the fifth component 350. In addition, the PPL robot 120 positions the eighth component 380 relative to the fifth component 350 such that a predefined distance (not labeled) is between the lower surface 386 of the eighth component 380 and the upper surface 356 of the fifth component 350. Also, gaps (not labeled) are provided or present between the at least one side surface 355 of the fifth component 350 and the at least one side surface 384 of the eighth component 380. Accordingly, and as described above with respect to FIG. 4B, the eighth component 380 is positioned and held independent of the fifth component 350. It should be understood that the build platform table 100 and the PPL robot 120 can position the fifth and eighth components 350, 380 adjacent to each other in an orientation different than shown in FIG. 9, and then rotate the fifth and eighth components 350, 380 such that the printer head 146 extrudes fused filament 148 vertically to form the fused filament weld 148a. It should also be understood from FIG. 9 and sub-assembly 34 that the teachings of the present disclosure provide for sub-assemblies with rotating parts to manufactured.

Referring to FIG. 10, a side view of two components assembled at desired positions and fused filament welded together to form a sub-assembly 35 is shown. Particularly, a nineth component 390 is fused filament welded (via a fused filament weld 148a) to the fifth component 350. As noted above, the fifth component 350 has the upper surface 352, at least one side surface 355, and the lower surface 356 defining the opening or space 357 (FIG. 7). The nineth component 390 has an upper surface 392, at least one side surface 394, and a lower surface 396. In addition, the nineth component 390 has an upper portion 395 extending from the upper surface 392 and an opening 397. In some variations, a separate component or feature 410 is disposed within the opening 397. For example, and as shown in FIG. 10, a linearly translatable part 410 is disposed within opening 397 and is configured to move along the x-axis shown in the figure. The fused filament weld 148a is bonded to the upper surface 352, the upper surface 392, the side surface(s) 355, and/or the side surface(s) 394 such that the nineth component 390 is securely attached to the fifth component 350. In addition, the PPL robot 120 positions the nineth component 390 relative to the fifth component 350 such that a predefined distance (not labeled) is between the lower surface 396 of the nineth component 390 and the upper surface 356 of the fifth component 350. Also, gaps (not labeled) are provided or present between the at least one side surface 355 of the fifth component 350 and the at least one side surface 394 of the nineth component 390. Accordingly, and as described above with respect to FIG. 4B, the nineth component 390 is positioned and held independent of the fifth component 350. It should be understood that the build platform table 100 and the PPL robot 120 can position the fifth and nineth components 350, 390 adjacent to each other in an orientation different than shown in FIG. 10, and then rotate the fifth and nineth components 350, 390 such that the printer head 146 extrudes fused filament 148 vertically to form the fused filament weld 148a. It should also be understood from FIG. 10 and sub-assembly 35 that the teachings of the present disclosure provide for sub-assemblies with sliding parts to be manufactured.

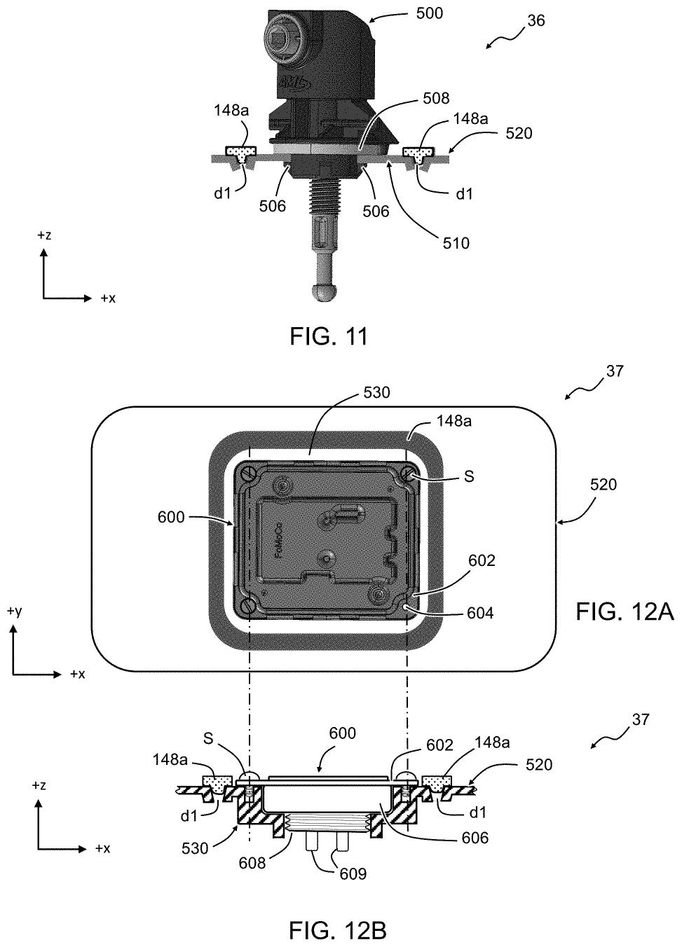

Referring to FIG. 11, a side view of two components assembled at desired positions and fused filament welded together to form a sub-assembly 36 is shown. Particularly, an adjuster 500 is releasable attached to a carrier structure 520. The adjuster has at least one clip 506, a retaining ring 508, and a welding ring 510. In some variations, the adjuster 500, retaining ring 508 and welding ring 510 are pre-assembled (e.g., using the assembly station 10) and the PPL robot 120 positions with the pre-assembled adjuster 500, retaining ring 508, and welding ring 510 within an opening (not labeled) of the carrier structure 520 such that a gap d1 is present between the welding ring 510 and the carrier structure 520. Also, the FFF robot 140 positions the printer head 146 (FIG. 1B) proximate to the gap d1 and extrudes fused filament 148 into the gap d1 such that a fused filament weld 148a is formed and securely attaches (i.e., welds) the welding ring 510 to the carrier structure 520. In the event that maintenance or replacement of the adjuster 500 is desired, the adjuster 500 is rotated relative to the welding ring 510 (e.g., rotated relative to the z-axis shown in FIG. 11) which is securely fused filament welded to the carrier structure 520 until the clips are released from or no longer engaged with the welding ring 510. Then, the adjuster 500 is moved or displaced out from within the welding ring 510 for repair or replacement by separate adjuster 500. In this manner, the assembly station 10 assembles components together than can be inspected and/or replaced during routine maintenance of such sub-assemblies 36.

Referring to FIGS. 11A-11B, a top view of two components assembled and fused filament welded together to form a sub-assembly 37 is shown in FIG. 12A and a side view of the two components assembled and fused filament welded together to form the sub-assembly 37 is shown FIG. 12B. Particularly, an electrical component 600 is releasable attached to the carrier structure 520. The electrical component 600 has a flange 602 and at least one aperture 604 extending through the flange 602, a component portion 606, a shaft portion 608 and at least one electrical contact 609. A plurality of fasteners ‘S’ (e.g., screws) are used to secure the electrical component 600 to a mounting structure 530 such that the electrical component 600 and the mounting structure 530 are pre-assembled (e.g., using the assembly station 10). Similar to the manufacture of the sub-assembly 36 described above, the PPL robot 120 positions the pre-assembled electrical component 600 and mounting structure 530 within an opening (not labeled) of the carrier structure 520 such that a gap d1 is present between the mounting structure 530 and the carrier structure 520. Also, the FFF robot 140 positions the printer head 146 (FIG. 1B) proximate to the gap d1 and extrudes fused filament 148 into the gap d1 such that a fused filament weld 148a is formed and securely attaches (i.e., welds) the mounting structure 530 to the carrier structure 520. In the event that maintenance or replacement of the electrical component 600 is desired, the fasteners S are removed (e.g., unscrewed) from the mounting structure 530, which is securely fused filament welded to the carrier structure 520, and the electrical component 600 is released from or no longer engaged with the mounting structure 530. Then, the electrical component 600 is moved or displaced out from within the mounting structure 530 for repair or replacement by a another electrical component 600. In this manner, the assembly station 10 assembles components together than can be inspected and/or replaced during routine maintenance of such sub-assemblies 37.

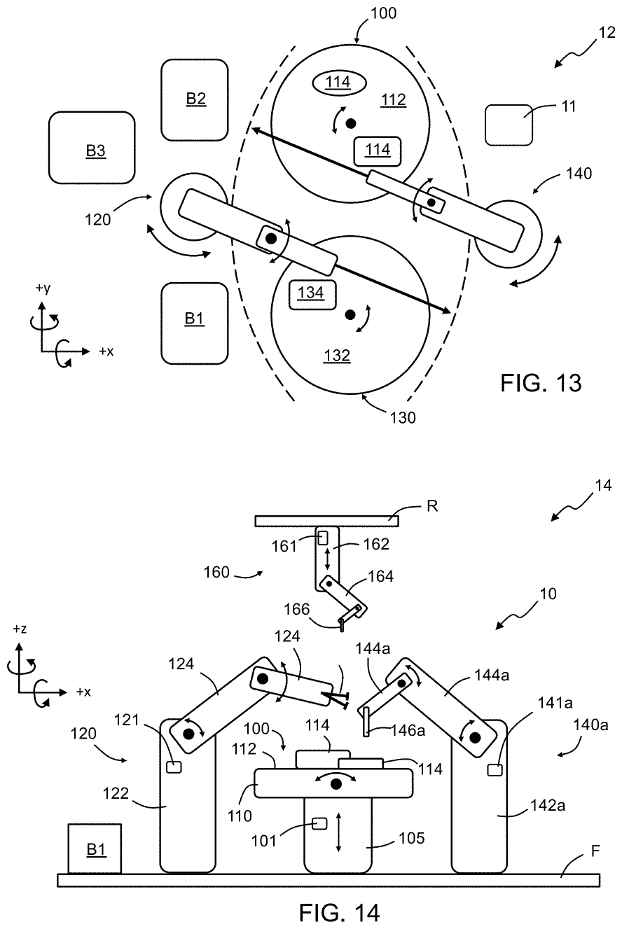

While FIGS. 1A-1B show and FIGS. 2-12B discuss assembly of sub-components using only one build platform table 100, more than one build platform table 100 can be included within an assembly station according to the teachings of the present disclosure. For example, and referring to FIG. 13, an assembly station 12 with a first build platform table 100 and a second build platform table 130 is shown. The first build platform table 100 has the at least one nest 114 and the second build platform table 130 has at an upper surface 132 and at least one nest 134. Both the first build platform table 100 and the second build platform table 130 are configured to move about three orthogonal axes, and the PPL robot 120 and the FFF robot 140 have access or can reach desired locations or positions on each of the first and second build platform tables 100, 130. In some variations, the PPL robot 120 and the FFF robot 140 have access or can reach all location or positions on each of the first and second build platform tables 100, 130. In addition the PPL robot 120 and the FFF robot 140 are configured to build or manufacture a set sub-assemblies on the first build platform table 100 and assemble the set of sub-assemblies to form another set of sub-assemblies or to form main assemblies on the second build platform table 130. In the alternative, or in addition to, the PPL robot 120 and the FFF robot 140 are configured to build or manufacture a set sub-assemblies on the second build platform table 100 and assemble the set of sub-assemblies to form another set of sub-assemblies or to form main assemblies on the first build platform table 130. In addition, the PPL robot 120 and the FFF robot 140 are configured to build or manufacture a set sub-assemblies on both the first and second build platform tables 100, 130 and assemble the set of sub-assemblies to form another set of sub-assemblies or to form main assemblies on the first platform table 100 and/or the second build platform table 130.

Referring to FIG. 14, an assembly station 14 with one or more robots 160 is shown. For example, the assembly station can include a first PPL robot 120, a second PPL robot 140a, and at least one FFF robot 160 with a controller 161, a base 162, and at least one arm 164 mounted to roof structure R. In some variations the FFF robot 140 is used or converted into the second PPL robot 140a. The second PPL robot 140a has a base 142a, at least one arm 144a, and an end effector 146a. The first and second PPL robots 120, 140a are configured to position and hold components in desired locations and the at least one FFF robot 160 with a printer head 166 is configured to fused filament weld the components together as discussed above for FFF robot 140. In at least one variation, the assembly station has a pair of FFF robots 160 with one of the FFF robots 160 dedicated primarily to a first build platform table (e.g., first build platform table 100 in FIG. 13) and another of the FFF robots 160 dedicated primarily to a second build platform table (e.g., second build platform table 130 in FIG. 13). For example, and referring to FIGS. 12 and 13, in some variations a first set of sub-assemblies are manufactured on the first build platform table 100 using the second PPL robot 140a and a first FFF robot 160 dedicated to the first build platform table 100 and a second set of sub-assemblies are manufactured on the second build platform table 130 using the first PPL robot 120 and a second FFF robot 160 dedicated to the second build platform table 130. In the alternative, or in addition to, a first set of sub-assemblies are manufactured on the first build platform table 100 using the second PPL robot 140a and a first FFF robot 160 dedicated to the first build platform table 100 and a second set of sub-assemblies, or main assemblies, are manufactured from the first set of sub-assemblies on the second build platform table 130 using the first PPL robot 120 and a second FFF robot 160 dedicated to the second build platform table 130.

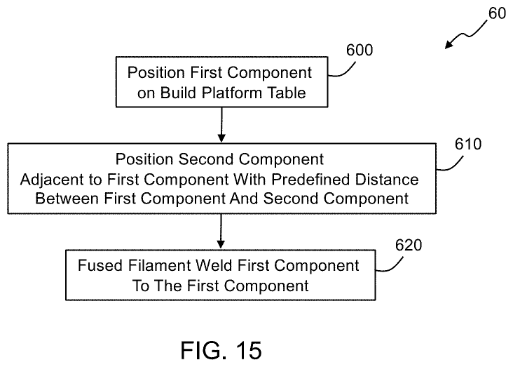

Referring now to FIG. 15, a method 60 for manufacturing an assembly of components includes positioning a first component on a build platform table at 600, positioning a second component adjacent to the first component at 610 such that a predefined distance is between the first component and the second component, and fused filament welding the first component to the second component at 620. In some variations, the first and second component are rotated such that fused filament is extruded vertically from a printer head into or onto the predefined distance between the first component and the second component. The first component is positioned on the build platform table and the second component is positioned adjacent to the first component with at least one PPL robot and the printer head is controlled by a FFF robot. Also, in at least one variation an electronic vision system (not shown) is used to adjust a robot's weld line, weld depth and/or weld width such that enhanced welds and enhanced welding of the two components together is provided.

In some variations, step 610 includes positioning the second component at predetermined location or an exact (or almost exact) position in space that is not referenced to the first component. That is, the second component is positioned free of any existing dimensional errors in the first component or a prior assembly containing the first component. Accordingly, filling a variable gap between the first and second components (i.e., fused filament welding) ensures each and every stage of the assembly is “true” to its desired or designed position, thereby allowing greater or wider tolerances for components in an assembly and reducing the cost of each component.

In this application, the term “module” and/or “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Words used to describe the relationship between elements should be interpreted in like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used to describe various elements, components, regions, layers and/or sections, these elements, components, regions, layers and/or sections, should not be limited by these terms. These terms may be only used to distinguish one element, component, region, layer and/or section, from another element, component, region, layer and/or section. Terms such as “first,” “second,” and other numerical terms when used herein do not imply a sequence or order unless clearly indicated by the context. Thus, a first element, component, region, layer or section, could be termed a second element, component, region, layer or section without departing from the teachings of the example forms. Furthermore, an element, component, region, layer or section may be termed a “second” element, component, region, layer or section, without the need for an element, component, region, layer or section termed a “first” element, component, region, layer or section.

Spacially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.”

Unless otherwise expressly indicated, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The terminology used herein is for the purpose of describing particular example forms only and is not intended to be limiting. The singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An assembly station comprising:
at least one build platform table configured to move about three orthogonal axes;
at least one part placement (PPL) robot configured to position and hold components on and above the at least one build platform table; and
at least one fused filament fabrication (FFF) robot comprising a printer head configured to fused filament weld at least two components together, wherein the at least one build platform table is configured to rotate during assembly of a plurality of components such that fused filament is extruded vertically from the printer head during fused filament welding of the at least two components together.

2. The assembly station according to claim 1, wherein the at least one PPL robot is configured to position and hold a first component a predetermined distance from a second component during fused filament welding of the first component to the second component with the at least one FFF robot.

3. The assembly station according to claim 2, wherein the predetermined distance is a welding gap between the first component and the second component.

4. The assembly station according to claim 3, wherein the at least one FFF robot and the printer head are configured to extrude fused filament into the welding gap.

5. The assembly station according to claim 2, wherein the predetermined distance is an isolation gap between the first component and the second component.

6. The assembly station according to claim 2, wherein the at least one build platform table is configured to hold a lens, the at least one PPL robot is configured to hold a lighting module adjacent to the lens with the predetermined distance between the lens and the lighting module, and the at least FFF robot is configured to fused filament weld the lighting module to the lens.

7. The assembly station according to claim 6, wherein the at least one FFF robot is configured to extrude sealant into at least a portion of the predetermined distance between the lens and the lighting module.

8. The assembly station according to claim 6, wherein the predetermined distance between the lens and the lighting module is a welding gap and the at least one build platform table and the at least one PPL robot are configured to move the lens and the lighting module together such that the printer head extrudes fused filament vertically into the welding gap to fused filament weld the lighting module to the lens.

9. The assembly station according to claim 1, wherein the at least one build platform table, the at least one PPL robot and the at least FFF robot are configured to assemble at least two sub-assemblies and configured to assemble the at least two sub-assemblies and form a main assembly.

10. The assembly station according to claim 9, wherein the at least two sub-assemblies are at least two head lamp sub-assemblies and the main assembly is a head lamp main assembly.

11. The assembly station according to claim 1, wherein the at least one build platform table is at least two build platform tables and the at least one PPL robot and the at least one FFF robot are configured to assemble sub-assemblies on one of the at least two build platform tables and to assemble to the sub-assembles into a main assembly on another of the at least two build platform tables.

12. The assembly station according to claim 1, wherein the at least one build platform table is at least two build platform tables and the at least one PPL robot and the at least one FFF robot are configured to assemble a first set of sub-assemblies on one of the at least two build platform tables and to assemble a second set of sub-assembles on another of the at least two build platform tables.

13. The assembly station according to claim 12, wherein the at least one PPL robot and the at least one FFF robot are configured to assemble the first set of sub-assembles and the second set of sub-assemblies to form main assemblies.

14. The assembly station according to claim 1, wherein the at least one build platform table is and the at least one PPL robot are mounted to a floor structure, and the at least one FFF robot is mounted to a roof structure above the at least one build platform table.

15. The assembly station according to claim 14, wherein the at least one build platform table is at least two build platform tables mounted to the floor structure, the at least one PPL robot is at least two PPL robots mounted to the floor structure, and the at least one FFF robot is at least two FFF robots mounted to the roof structure above the at least two build platform tables.

16. An assembly station comprising:
at least one build platform table configured to move about three orthogonal axes;
at least one part placement (PPL) robot configured to position and hold components on and above the at least one build platform table; and
at least one fused filament fabrication (FFF) robot comprising a printer head configured to fused filament weld at least two components together, wherein the at least one PPL robot is configured to position and hold a first component a predetermined distance from a second component and the at least one build platform table is configured to rotate such that fused filament is extruded vertically from the printer head to fused filament weld the at least two components together.

17. The assembly station according to claim 16, wherein a first portion of the predetermined distance is a welding gap between the first component and the second component and a second portion of the predetermined distance is an isolation gap between the first component and the second component.

18. The assembly station according to claim 17, wherein the at least one FFF robot and the printer head are configured to extrude fused filament into the welding gap.

19. An assembly station comprising:
two build platform tables configured to move about three orthogonal axes;
two part placement (PPL) robots configured to position and hold components on and above the two build platform tables; and
a fused filament fabrication (FFF) robot comprising a printer head configured to fused filament weld at least two components together, wherein the two PPL robots are configured to position and assemble a first component a predetermined distance from a second component such that fused filament is extruded vertically from the printer head to fused filament weld the first component to the second component.

20. The assembly station according to claim 19, wherein the first component is a lens, the second component is a lighting module, the predetermined distance between the lens and the lighting module is a welding gap, at least one of the two build platform tables and at least one of the two PPL robots are configured to move the lens and the lighting module together such that the printer head extrudes fused filament vertically into the welding gap to fused filament weld the lighting module to the lens.
